(19) United States
(12) Patent Application Publication
(10) Pub. No.: US 2012/0125528 A1
(43) Pub. Date: May 24, 2012

(54) APPARATUS FOR LABELLING CONTAINERS BY MEANS OF SLEEVE-LIKE LABELS

(76) Inventors: Ireneo Orlandi, Curtatone (IT); Daniele Marastini, San Giovanni In Persiceto (IT)

(21) Appl. No.: 13/261,149

(22) PCT Filed: Jul. 14, 2010
(86) PCT No.: PCT/IB2010/053217

§ 371 Date: Jan. 23, 2012

(30) Foreign Application Priority Data
Jul. 24, 2009 (IT) VR2009A000112

(51) Int. Cl. B65C 3/00; B65C 9/26

(52) U.S. Cl. 156/184; 156/387

(57) ABSTRACT

An apparatus for labelling containers by means of heat-shrink sleeve-like labels, comprising a frame which supports at least one device for handling containers to be labelled and which is provided with at least one applicator, which is adapted to transfer a respective sleeve-like label onto the outer surface of at least one container to be labelled, a feeder being provided which is adapted to make the sleeve-like labels available to the at least one applicator, there being a printer adapted to decorate at least one portion of the sleeve-like labels.

The present invention relates to an apparatus for labelling containers by means of sleeve-like labels.

### BACKGROUND OF THE INVENTION

Nowadays apparatuses are widely known for carrying out the continuous labelling of containers, such as bottles or the like, which allow to transfer on the containers to be labelled sleeve-like labels, also known as “shrink sleeve” labels, made of polymeric heat-shrink material.

Specifically, sleeve-like labels are fitted over the containers, which are subsequently sent to a heating station in order to bring about the shrinkage of the sleeve-like labels on the outside surface of the container, in order to subsequently take on its shape.

In general, apparatuses of this type are constituted by a carousel, which is rotatable about a substantially vertical axis of rotation and which has, along its peripheral region, a plurality of support pans for respective containers to be labelled which are supplied by a belt feeder and which are then sent, after a partial rotation of the carousel about its axis, to the heating station by means of a special conveyor.

In a first type of known apparatuses of this sort, there is a station for feeding the sleeve-like labels, which is separate from the carousel and which is provided with a supporting roller for a roll of a flat tubular element made from a printed film of heat-shrink material. Downstream of the supporting roller, there are means for cropping the tubular element in order to provide, in sequence, the sleeve-like labels to be applied to the containers positioned on the carousel.

In another type of known apparatus, the sleeve-like labels are made directly on the carousel by means of winding portions of a printed film around a spindle, which is arranged above a respective pan of the carousel. The portions of printed film that are wound by the spindles are obtained by taking from a reel a pre-printed continuous film which is cut to measure by way of cutting means that are associated with reading means that are adapted to detect, along the length of the continuous film, suitable graphic signs or “markers” which identify the areas of the continuous film at which to make the cut.

Once the winding of the printed portions of film onto the respective spindle is completed, such spindle is brought, pulled by the rotation of the carousel about its axis, at a heat-sealing device which welds the two opposite flaps of the portions of printed film together, so as to make the sleeve-like label, which is then fitted over the container to be labelled.

In some cases, the heat-sealing device is associated with each spindle and rotates together with it.

It is evident that all of the apparatuses described above use reels that are pre-printed, generally using suitable printing machines such as for example flexographic, offset or rotogravure machines.

This gives rise to various drawbacks, among which, in particular, the need to manage, in stores, the various reels of the different types of label and the requirement to provide optical means, or means of recognition in general, that are adapted to detect the area at which to make the cut of the film being unwound from the reel.

A further drawback of the apparatuses used nowadays is determined by the fact that, during the step of heat-sealing the flaps of the label in order to make the sleeves, the effect of the inks applied previously is often compromised owing to the high temperatures necessary for the heat-sealing.

### SUMMARY OF THE INVENTION

The aim of the present invention is to solve the above mentioned problems, by providing an apparatus for labelling containers by means of sleeve-like labels that is extremely flexible in operation and which allows simplified stores management of the labels to be applied, with respect to the known art.

Within this aim, an object of the invention is to provide an apparatus for labelling containers by means of sleeve-like labels that is capable of offering wide-ranging guarantees of reliability and safety in use.

A further object of the present invention is to provide an apparatus for labelling containers in which it is not necessary to “follow” or monitor the print step which, in the apparatuses used nowadays, is not constant along the unwinding of the reel.

A further object of the present invention is to provide an apparatus for labelling containers by means of sleeve-like labels that is constructively simple, so as to be advantageous also from a purely economic viewpoint.

This aim, as well as these and other objects which will become better apparent hereinafter, are achieved by an apparatus for labelling containers by means of heat-shrink sleeve-like labels, according to the invention, comprising a frame which supports at least one device for handling containers to be labelled and which is provided with at least one applicator, which is adapted to transfer a respective sleeve-like label onto the outer surface of at least one container to be labelled, feeder means being provided that are adapted to make said sleeve-like labels available to the applicator, characterized in that it comprises printing means adapted to decorate at least one portion of said sleeve-like labels.

According to a further aspect, the present invention relates to a method for labelling containers with heat-shrink sleeve-like labels by means of an apparatus for labelling containers, comprising a step of feeding at least one sleeve-like label to an applicator and a step of transferring said sleeve-like label fed to said applicator onto a container that is supported by the apparatus, characterized in that it comprises a step of printing at least one portion of said sleeve-like label before said transfer step.

### BRIEF DESCRIPTION OF THE DRAWINGS

Further characteristics and advantages of the invention will become better apparent from the detailed description that follows of a preferred, but not exclusive, embodiment of the apparatus according to the invention, illustrated by way of non-limiting example in the accompanying drawings, wherein:

FIG. 1 is a schematic top view of a first embodiment of the apparatus for labelling according to the invention;

FIGS. 2 and 3 show, in a view similar to that of FIG. 1, two further embodiments of the apparatus for labelling according to the invention;

FIG. 4 is an enlarged-scale top view of a portion of the apparatus for labelling according to the invention;

FIG. 5 is a schematic side elevation view of a further embodiment of the feeder means;

FIG. 6 is a sectional view of the apparatus, taken along the line VI-VI of FIG. 5;

Figures from 7 to 10 show, in sequence and in side elevation view, the winding, on a spindle arranged on the peripheral region of the carousel, of a portion of film to be printed, the heat-sealing of the opposite flaps of the film to obtain the sleeve-like label, the printing of the sleeve-like label, and the transfer onto a bottle.

### DESCRIPTION OF THE PREFERRED EMBODIMENTS

With reference to the figures, an apparatus for labelling containers by means of sleeve-like labels, generally designated by the reference numeral 1, comprises, in particular, a fixed frame upon which a device for handling containers 3 to be labelled is mounted.

In the present description and in the accompanying drawings such handling device is constituted by at least one carousel 2, that is rotatable about a substantially vertical axis of rotation 100, and which is designed to support the containers 3 to be labelled, during the process of application of the sleeve-like labels.

However, there is no reason why the subject matter of the present invention cannot be applied on apparatuses having a different structure such as, for example, so-called linear labelling apparatuses.

In more detail, the carousel 2 is put into rotation, with respect to the fixed frame of the machine, about its axis of rotation 100, in a direction of rotation that is indicated in the figures with the letter A.

The carousel 2 has, along its peripheral region, a plurality of applicators 4, which are designed to transfer a respective sleeve-like label 5 onto the outer surface 3a of at least one container 3 to be labelled, which is also supported by the carousel 2.

The containers 3 to be labelled are fed to the carousel 2 by a belt feeder 6, while a conveyor 7 takes the labelled containers 3 from the carousel 2 in order to bring them to a heating station (not shown in the figures), in order to obtain the heat-shrinking of the sleeve-like labels 5 which thus take on the outside shape of the container 3 over which they are fitted.

Conveniently, between the belt feeder 6 and the carousel 2 there is an entry feed wheel 8, the function of which is to convey the containers 3 to be labelled onto the carousel 2. Similarly, between the carousel 2 and the conveyor 7 there is an exit feed wheel 9, the function of which is to remove the labelled containers 3 from the carousel 2 and transfer them to the conveyor 7.

On the apparatus 1 there are, furthermore, feeder means 10, which will be described in detail hereinbelow, which are adapted to make available to the applicators 4 the sleeve-like labels 5 to be transferred onto the containers 3.

According to the present invention, the apparatus 1 is provided with printing means 20 that are adapted to decorate at least one portion of the sleeve-like labels 5.

Advisably, the printing means 20 can be arranged in a fixed position with respect to the carousel 2 or can also be integrally connected to the carousel 2.

In general, according to requirements, the printing means 20 can be constituted irrespectively by any device among: an inkjet printing device, a laser printing device, a screen printing device or flexographic printing device, an offset printing device, a plotter-based printing device, a sublimatic ink printing device.

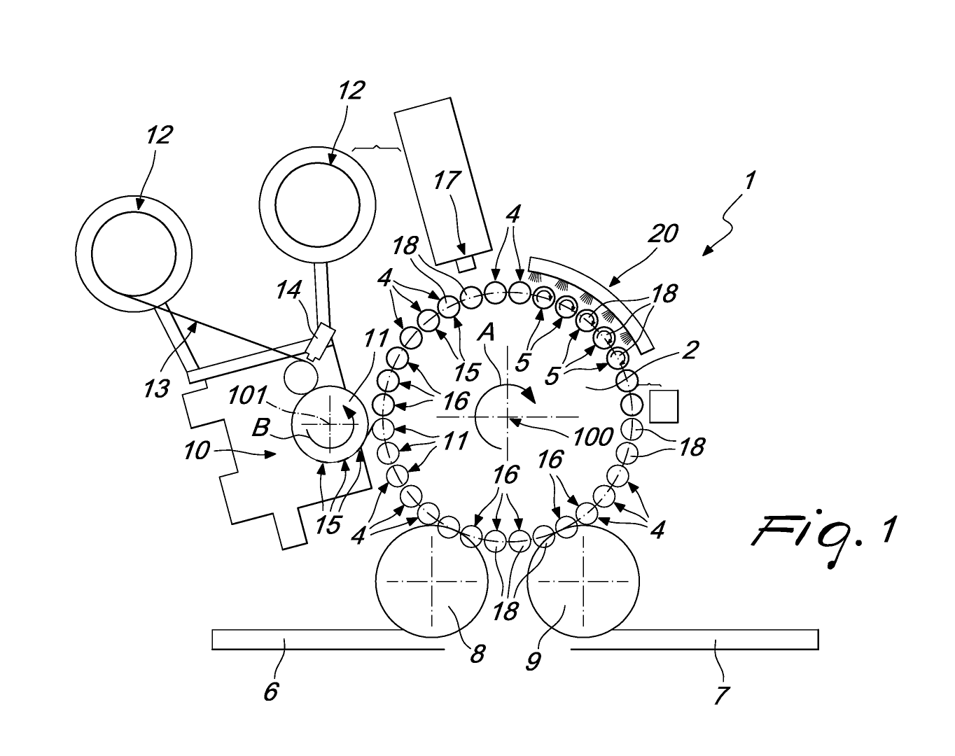

Moving on now to describe some embodiments of the apparatus 1, it may be observed that, with particular reference to FIG. 1, according to a first embodiment, the feeder means 10 can be provided by means of an element for unwinding that is constituted, for example, by a transfer drum 11, from which a reel 12 of a printable film 13 is unwound.

Advisably, the feeder means 10 also comprise cutting means 14, which are designed to slice the printable film 13 unwound from the reel 12, to make portions of film 15, which are subsequently used to form the sleeve-like labels 5.

As shown in Figures from 1 to 3, the transfer drum 11 is rotatable about a respective axis of movement 101 according to a direction of rotation, indicated with the letter B, that is opposite to the direction of rotation A of the carousel 2.

According to a practical embodiment, the transfer drum 11 has, in a manner that is per se known, a cylindrical side wall on which a plurality of holes are formed that are connected to a pneumatic device that is adapted to aspire air into the transfer drum 11 or to expel air from the transfer drum 11, through such holes, as a function of the angular position assumed by such holes, during the rotation of the transfer drum 11, with respect to the axis of movement 101.

In practice, by means of the aspiration of air through the holes it is possible to keep the portions of film 15, obtained one at a time by way of the cutting means 14, in adherence to the cylindrical side wall of the transfer drum 11 and, by means of the expulsion of air from the transfer drum 11, it is instead possible to detach the portions of film 15 from the cylindrical side wall of the transfer drum 11 in order to allow them to move onto respective wrapping means 16, which are located downstream of the transfer drum 11 and which are arranged along the peripheral region of the carousel 2, above the containers 3 to be labelled.

To complete the fabrication of the sleeve-like labels 5, there are heat-sealing means 17 that carry out the bonding of the opposite flaps 15a, 15b of the portions of film 15 wrapped by the wrapping means 16 of the carousel 2.

By way of example, the heat-sealing means 17 can be of the ultrasound type, as disclosed in W02004/020291, or of the laser type, as disclosed in W02007/031502.

Advantageously, the wrapping means 16 are constituted by a plurality of spindles 18, which are substantially cylindrical and are distributed, so as to be mutually angularly spaced, along the peripheral region of the carousel 2.

The spindles 18 are oriented, with their respective axes, substantially parallel to the axis of rotation 100 of the carousel 2 and are engageable, on their own outer surface, by a portion of film made available by the transfer drum 11, when they are brought into a position facing the transfer drum 11, during the rotation of the carousel 2.

Further, the spindles 18 are actuated so as to rotate about their corresponding axis in order to wrap, around their outside surface, the portions of film 15 taken from the transfer drum 11.

To ensure an optimal adherence of the portions of film 15 on the outside surface of the spindles 18, there are means for aspiration of air through a plurality of openings formed on the outside surface of the spindles 18.

Advantageously, the printing means 20 are adapted to decorate the portions of film 15 or the sleeve-like labels 5, when the portions of film 15 or the sleeve-like labels 5 engage the wrapping means 16.

In particular, the printing means 20 are arranged at the peripheral region of the carousel 2 so as to face at least one of the spindles 18 during the rotation of the carousel 2 about its axis of rotation 100.

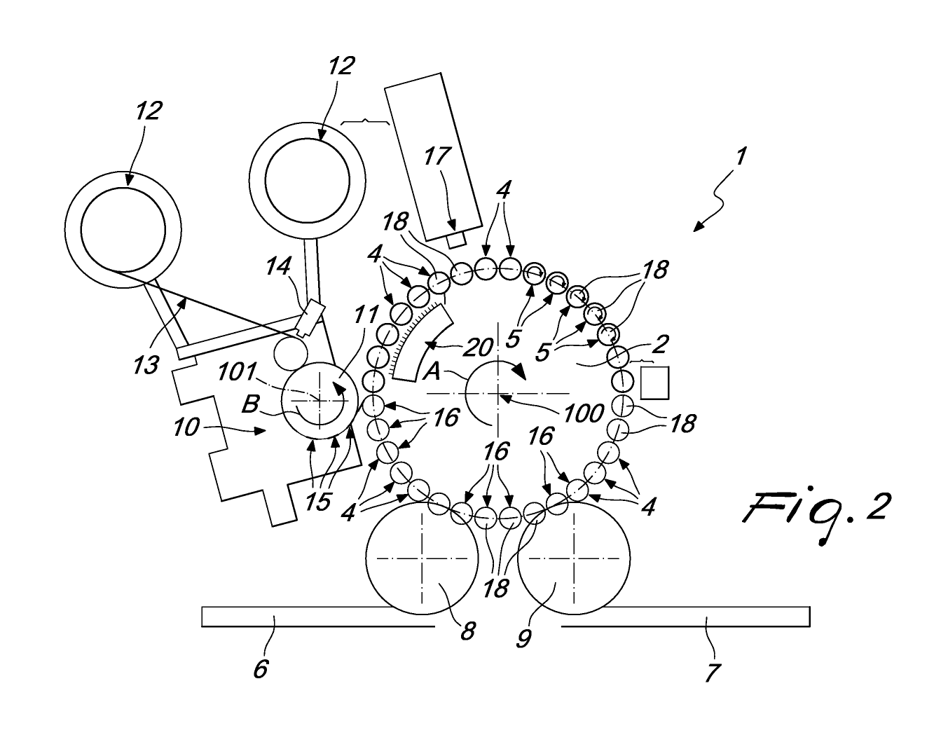

It should be noted that the printing means 20 can be positioned outside the area affected by the passing of the spindles 18 with respect to the axis of rotation 100 of the carousel 2, as shown in FIG. 1, or they can be arranged between the area affected by the passing of the spindles 18 and the axis of rotation 100 of the carousel 2, as shown in FIG. 2.

With reference to the embodiments of FIGS. 1 and 2, the printing means 20 are arranged so as to enable the decoration of the side of the sleeve-like labels 5 that is designed to be directed away from the container 3 to be labelled.

More specifically, as shown in FIG. 1, the system can be designed to proceed with the printing of the sleeve-like labels 5 when they are already formed and supported by the respective spindle 18.

In this case, the printing means 20 are arranged downstream, with respect to the direction of rotation A of the carousel 2, of the heat-sealing means 17.

Alternatively, as shown in FIG. 2, the printing means 20 can be interposed between the transfer drum 11 and the heat-sealing means 17, so as to provide the printing on the portions of film 15 when they are wrapped around the spindles 18.

Advisably, the printing means are arranged along a circular arc so as to face the spindles 18 along a portion of their circular path, during the rotation of the carousel 2 about the corresponding rotation axis 100.

To allow printing on all of the surface of the portions of film 15 or of the sleeve-like labels 5, the spindles 18 are, advantageously, put into rotation about their axis, during their passage at the printing means 20.

According to a different embodiment, the printing means 20 can be designed to decorate the side of the sleeve-like labels 5 that is designed to be directed towards the container 3 to be labelled.

Obviously, in this case, the sleeve-like labels 5 are made from a film that is substantially transparent.

In a possible solution of this type, the printing means 20 are accommodated at least partially inside the spindles 18 and are configured to decorate, from inside the spindles 18, the portions of film 15 or the sleeve-like labels 5 that are wrapped around the spindles 18.

This solution can be obtained by means of ink sprayers, not shown, which are positioned in an axial cavity formed in the spindles 18 and are in communication with the outside by means of micro-holes formed on the outer surface of the spindles 18.

In another possible solution, the printing means 20 are implemented by means of at least one printing device 21 that is adapted to apply a layer of print onto the outer surface of the spindles 18, before the portions of film 15 are transferred onto them. The layer of print applied by the printing device 21 can be constituted by inks and is designed to be transferred onto the portions of film 15 that will be wrapped around the spindles 18.

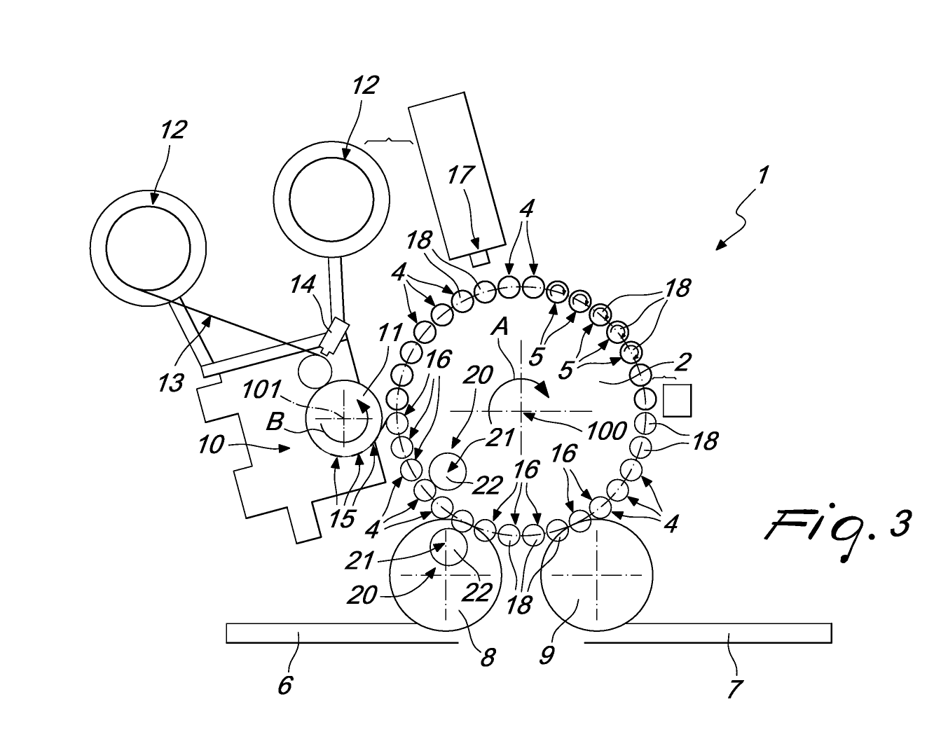

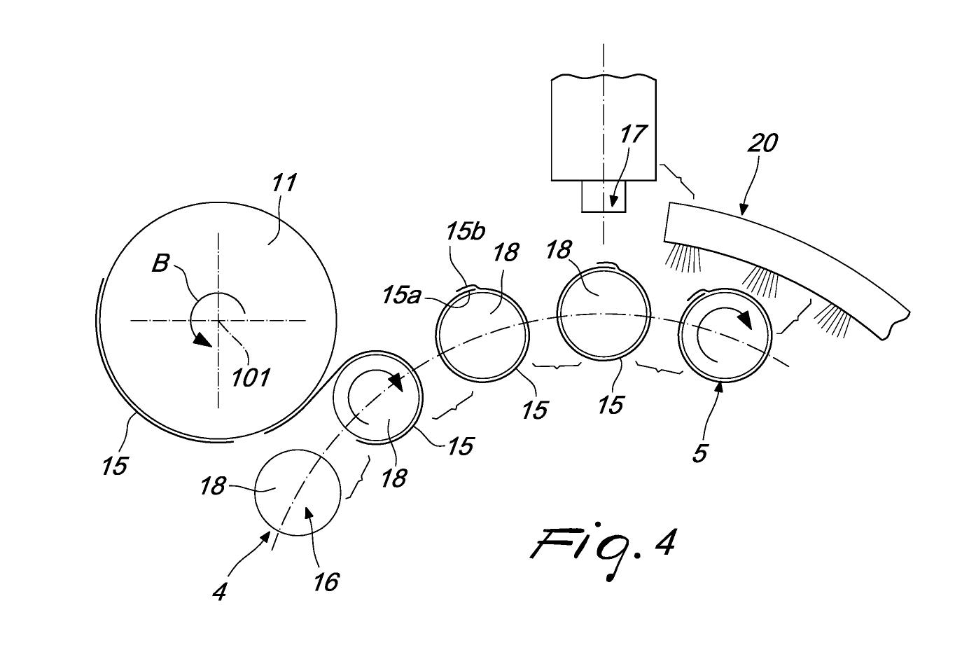

As shown in FIG. 3, the printing device 21 can be constituted by one or more print cylinders 22, for example of the rubberised type with printing plates, which are engaged on their lateral surface by the spindles 18 that are pulled by the carousel 2 before the portions of film 15 are wrapped around them.

However, there is no reason why the printing device 21 cannot be implemented by way of means that are similar to those shown in other embodiments.

In a further embodiment of the apparatus 1 according to the invention, the printing means 20 are interposed between the reel 12 and the wrapping means 16, in order to be able to carry out the decoration of at least one side of the film 15, which is unwound from the reel 12, upstream of the cutting means 14, or of the portions of film 15, downstream of the cutting means 14, according to the direction of unwinding of the reel 12, and before their engagement with the wrapping means 16.

In this case, the printing means 20 can, for example, be constituted by a laser printer or an ink jet printer of any suitable type or by print cylinders that engage with the outer surface of the transfer drum 11 so as to enable the decoration of the portions of film 15 adherent thereto.

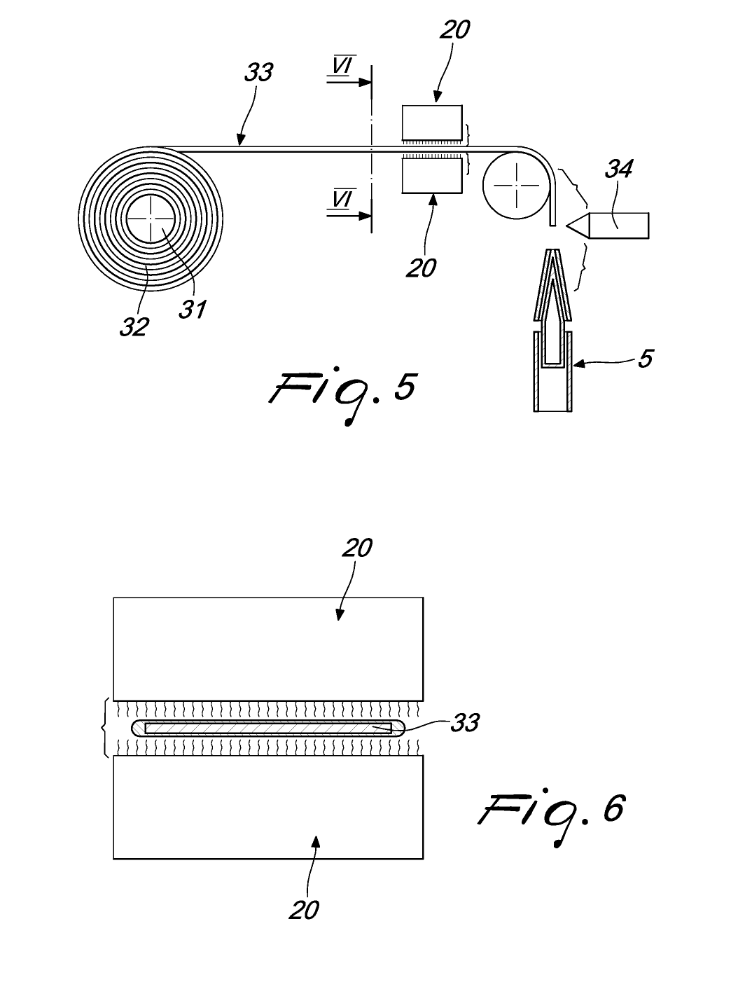

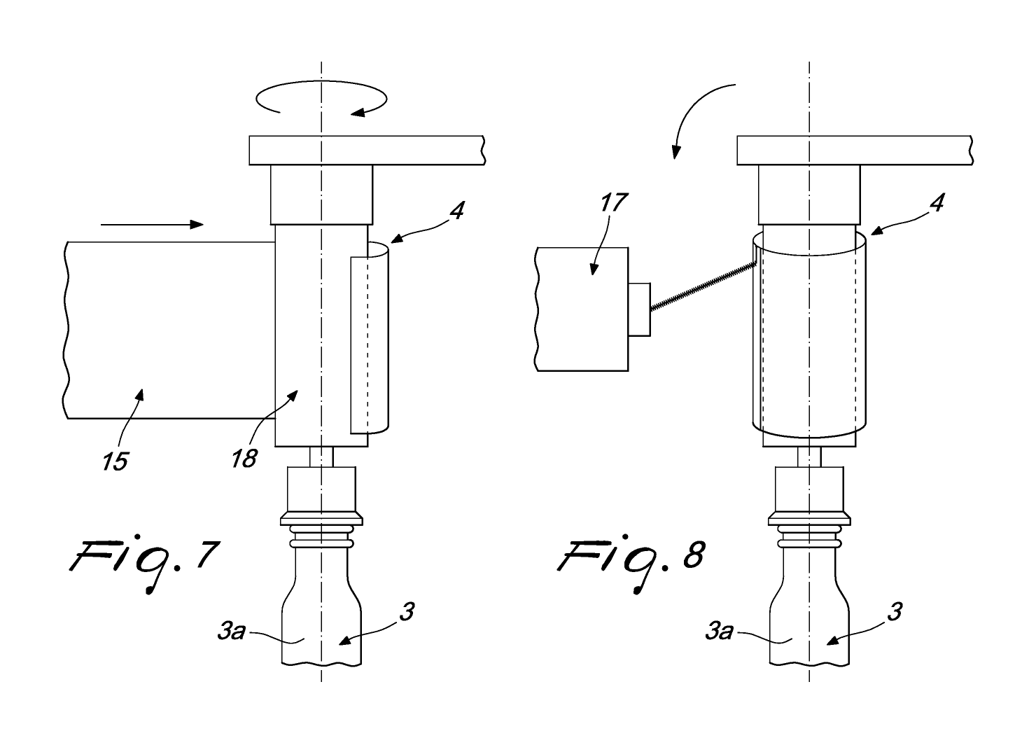

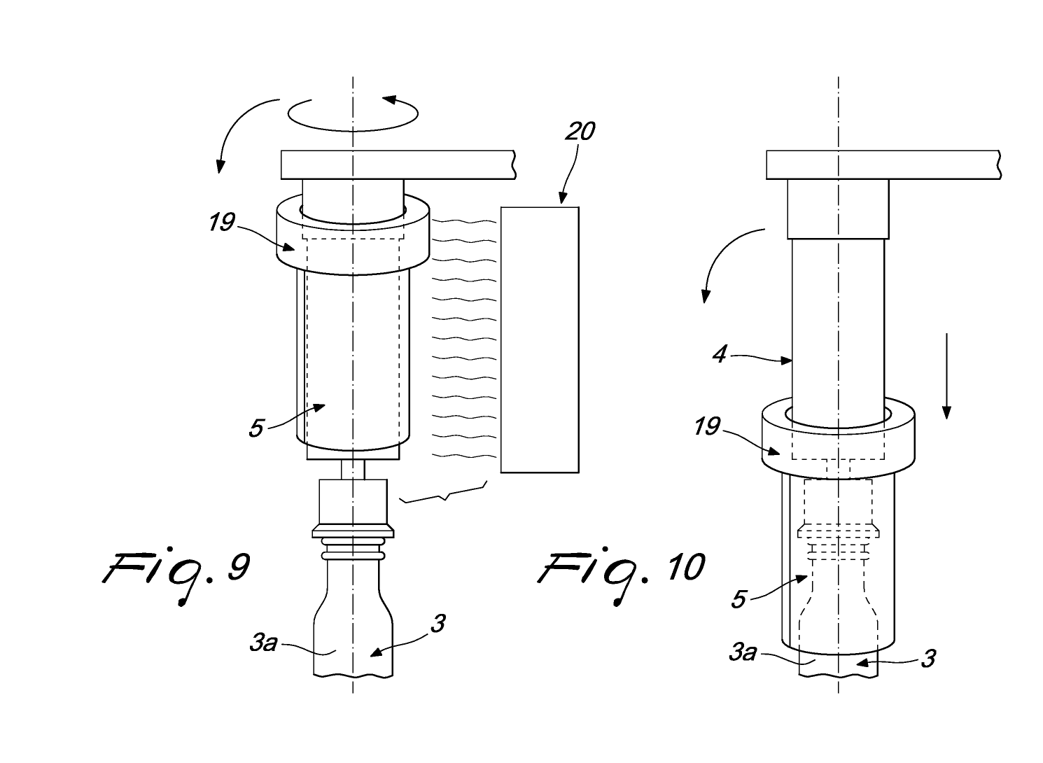

With reference to FIGS. 5 and 6, in an alternative embodiment of the feeder means 10 there is a supporting roller 31 for a roll 32 of a flat tubular element 33, formed from a printable film, as well as means 34 for cropping the flat tubular element 33 being unwound from the roller 31 for supporting the roll 32.

The cropping means 34 act transversally with respect to the longitudinal length of the flat tubular element 33, so as to make sections 35 of the tubular element 33 that are designed to be radially opened in order to obtain the sleeve-like labels 5 to be fitted onto the containers 3 carried by the carousel 2.

In this specific case, the printing means 20 can be, advisably, provided between the roll 32 and the cropping means 34, so as to allow the execution of a decoration on at least one portion of the flat tubular element 33, being unwound from the supporting roller 31, when such portion to be decorated is still flat in its development.

However, there is no reason why the sections 35 of tubular element 33 cannot be transferred, after their expansion, to a spindle 18 of the carousel 2, and there is no reason why the printing means 20 cannot execute the decoration of such sections, when they are engaged by the corresponding spindle 18, in a similar manner to the embodiments described above.

It is also possible for the printing means 20 to be arranged in such a way that they carry out the printing when the sleeve-like label 5 is already transferred to the containers to be labelled 3. In this case it is however advisable to provide aspiration devices, which act between the outer surface of the container 3 to be labelled and the inside surface of the sleeve-like label 5 that has already been transferred, and which enable the sleeve-like label 5 to adhere to the outer surface of the container 3 to be labelled so as to allow an accurate print.

For the purposes of completeness of description, it should be noted that the applicators 4 have, in a per se known manner, means 19 for sending the decorated sleeve-like labels 5 from the printing means 20 to the containers 3.

The sending means 19 can for example be constituted by a thrust ring that is designed to be coaxially moved towards a respective spindle 18 in order to push the sleeve-like label 5 that is wrapped around it towards the container 3 to be labelled which is positioned below the spindle 18.

To facilitate this operation, it is advisable to interrupt the action of the aspiration means acting on the spindle 18 and to activate means for the expulsion of air from its openings located on its outer surface, so as to obtain a detachment of the sleeve-like label 5 from the outer surface of the spindle 18 over which it is fitted.

In practice, by means of the apparatus according to the invention it is possible to execute a method for labelling containers with sleeve-like labels, which consists, substantially, in a step of feeding at least one sleeve-like element 5 to an applicator 4 arranged in the peripheral region of the carousel 2 and in a step of transferring the sleeve-like element 5 supplied to the applicator 4 on a container 3 supported by the apparatus 1 and, in the specific case, by the carousel 2.

The distinctive characteristic of such method consists in the fact that it provides for a step of printing at least one portion of the sleeve-like label 5, before the aforementioned step of transferring it to the container 3.

According to a preferred embodiment of the method, the aforementioned feeding step provides for carrying out the following operations: a step of unwinding from the reel 12 the printable film 13, a step of cutting the printable film 13 in order to obtain, in sequence, portions of film 15, designed to provide the sleeve-like labels 5, a step of wrapping each portion of film 15 around a respective spindle 18 that is supported, so that it can rotate about its own axis, by the peripheral region of the carousel 2 and, finally, the printing step which is, advantageously, performed when the portion of film 15, or the sleeve-like label 5, is wrapped around the respective spindle 18.

In practice it has been found that in all the embodiments the invention is capable of fully achieving the intended aim and objects.

All the characteristics of the invention, indicated above as advantageous, advisable or similar, may also be missing or be substituted by equivalent characteristics.

The individual characteristics set out in reference to general teachings or to specific embodiments may all be present in other embodiments or may substitute characteristics in such embodiments.

The invention thus conceived is susceptible of numerous modifications and variations, all of which are within the scope of the appended claims.

In practice the materials employed, provided they are compatible with the specific use, as well as the dimensions and the shapes, may be any according to requirements.

Moreover, all the details may be substituted by other, technically equivalent elements.

The disclosures in Italian Patent Application No. VR2009A000112 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-15. (canceled)

16. An apparatus for labelling containers by means of heat-shrink sleeve-like labels, comprising a frame which supports at least one device for handling containers to be labelled and which is provided with at least one applicator, which is adapted to transfer a respective sleeve-like label onto the outer surface of at least one container to be labelled, feeder means being provided which are adapted to make said sleeve-like labels available to said at least one applicator, said feeder means comprising an element for unwinding a reel of printable film and means for cutting said printable film unwound from said reel in order to provide portions of film adapted to form said sleeve-like labels, means for wrapping said portions of film and means for heat-sealing the opposite flaps of said portions of film wrapped by said wrapping means in order to obtain said sleeve-like labels being provided, further comprising printing means adapted to decorate at least one portion of said sleeve-like labels or said portions of film when said portions of film or said sleeve-like labels engage said wrapping means.

17. The apparatus according to claim 16, wherein said at least one handling device comprises a supporting carousel which is provided peripherally with said at least one applicator.

18. The apparatus according to claim 17, wherein said wrapping means comprise a plurality of spindles, which are substantially cylindrical and are distributed, so as to be mutually angularly spaced, along the peripheral region of said carousel, said spindles being each engageable, on its own outer surface, by respective portions of film and being actuatable so as to rotate about their corresponding axis in order to wrap said portions of film.

19. The apparatus according to claim 16, wherein said printing means are adapted to decorate the side of said sleeve-like labels that is designed to be directed away from said container to be labelled.

20. The apparatus according to claim 18, wherein said printing means are arranged at a peripheral region of said carousel so as to face at least one of said spindles during the rotation of said carousel about said rotation axis.

21. The apparatus according to claim 18, wherein said printing means are arranged along a circular arc so as to face said spindles along a portion of their circular path, during the rotation of said carousel about the corresponding rotation axis.

22. The apparatus according to claim 16, wherein said printing means are adapted to decorate the side of said sleeve-like labels that is designed to be directed toward said container to be labelled.

23. The apparatus according to claim 18, wherein said printing means are accommodated at least partially in said spindles and are configured so as to decorate, from the inside of said spindles, said portions of film or said sleeve-like labels wrapped around said spindles.

24. The apparatus according to claim 18, wherein said printing means comprise at least one printing device that is adapted to apply to the outer surface of said spindles a layer of print that is designed to be transferred onto the portions of film designed to be wrapped by said spindles.

25. The apparatus according to claim 16, wherein said printing means are interposed between said reel and said wrapping means in order to print at least one face of said printable film or of said portions of film.

26. The apparatus according to claim 16, wherein said feeder means comprise a supporting roller for a roll of a flat tubular element of film and means for cropping said flat tubular element being unwound from said supporting roller transversely to its longitudinal extension, in order to provide said sleeve-like labels, said printing means being adapted to decorate at least one portion of said flat tubular element being unwound from said supporting roller.

27. The apparatus according to claim 17, wherein said printing means are arranged in a fixed position with respect to said carousel.

28. The apparatus according to claim 17, wherein said printing means are jointly connected to said carousel.

29. The apparatus according to claim 16, wherein said printing means comprise any device among an inkjet printing device, a laser printing device, a screen printing device or flexographic printing device, an offset printing device, a plotter-based printing device, and a sublimatic ink printing device.

30. A method for labelling containers with heat-shrink sleeve-like labels by means of an apparatus for labelling containers, comprising a step of feeding at least one sleeve-like label to an applicator and a step of transferring said sleeve-like label fed to said applicator onto a container that is supported by said apparatus, said feeding step providing for performing a step of unwinding from a reel a printable film, a step of cutting said printable film in order to obtain in sequence portions of film designed to provide said sleeve-like labels, and a step of wrapping each one of said portions of film around a respective spindle that is supported so that it can rotate about its own axis by the peripheral region of a carousel, further comprising a step of printing at least one portion of said sleeve-like label, or said portion of film, wrapped around the respective spindle before said transfer step.
